(19) United States
(12) Patent Application Publication
(10) Pub. No.: US 2024/0406078 A1
(43) Pub. Date: Dec. 5, 2024

(54) USER FEEDBACK COLLECTION FOR APPLICATION QOE PREDICTION

(71) Applicant: Cisco Technology, Inc., San Jose, CA (US)

(72) Inventors: Pierre-André Savalle, Rueil-Malmaison (FR); Jean-Philippe VASSEUR, Combloux (FR); Grégory MERMOUD, Venthône (CH); Andrea DI PIETRO, Frejus (FR); Grégoire MAGENDIE, Lamorlaye (FR)

(21) Appl. No.: 18/205,247

(22) Filed: Jun. 2, 2023

(51) Int. Cl. H04L 41/5025; H04L 41/0816; H04L 41/5067; H04L 43/04; H04L 67/75

(52) U.S. Cl. CPC H04L 41/5025; H04L 41/0816; H04L 41/5067; H04L 43/04; H04L 67/75

(57) ABSTRACT

In one embodiment, a device makes, using a prediction model, a prediction regarding a quality of experience metric for an online application, based on telemetry from a network used to access the network. The device determines a degree of uncertainty associated with the prediction. The device selects one or more users of the online application from which user feedback should be requested, based on the degree of uncertainty. The device requests that the one or more users provide user feedback regarding their satisfaction with the online application.

### TECHNICAL FIELD

The present disclosure relates generally to computer networks, and, more particularly, to user feedback collection for application quality of experience (QoE) prediction.

### BACKGROUND

Traditionally, network administrators have used service level agreements (SLAs) as a proxy for the quality of experience (QoE) of online applications from the standpoint of their users. These SLAs take the form of thresholds for various network characteristics, such as delay, loss, jitter, etc., and are viewed as the dividing lines between acceptable application experience or degraded application experience. For instance, in the case of voice applications, the usual SLA boundaries are 150 ms for delay, 50 ms for jitter, and maximum of 3% packet loss. This is typically done for each class/type of application of interest (e.g., videoconferencing, audio, etc.).

With the recent advancements in machine learning, it now becomes possible to predict the QoE of applications, without having to rely on static SLA thresholds as a proxy. In such cases, the most reliable source of ground truth for purposes of training the prediction model is user feedback from the users of the application itself regarding their subjective beliefs regarding their experiences. Generally speaking, the more feedback there is, the better the performance of the prediction model. However, perpetually asking every user for QoE feedback is impractical, as doing so can impinge on their productivity and also become an annoyance. Consequently, many users may begin to ignore the requests entirely or even start to let their annoyance with the surveys influence their QoE feedback regarding the application.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIGS. 4A-4B illustrate example software defined network (SDN) implementations;

FIG. 5 illustrates an example architecture for user feedback collection for application quality of experience (QoE) prediction;

FIG. 6 illustrates an example of active learning simulations; and

FIG. 7 illustrates an example simplified procedure for user feedback collection for application QoE prediction.

### DESCRIPTION OF EXAMPLE EMBODIMENTS

### Overview

According to one or more embodiments of the disclosure, a device makes, using a prediction model, a prediction regarding a quality of experience metric for an online application, based on telemetry from a network used to access the network. The device determines a degree of uncertainty associated with the prediction. The device selects one or more users of the online application from which user feedback should be requested, based on the degree of uncertainty. The device requests that the one or more users provide user feedback regarding their satisfaction with the online application.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

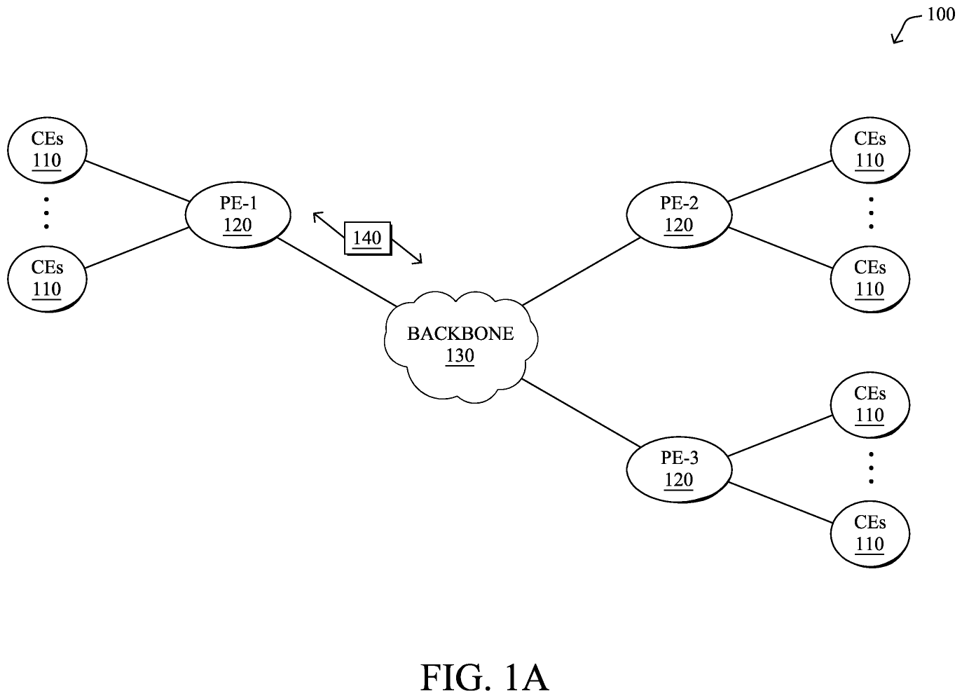

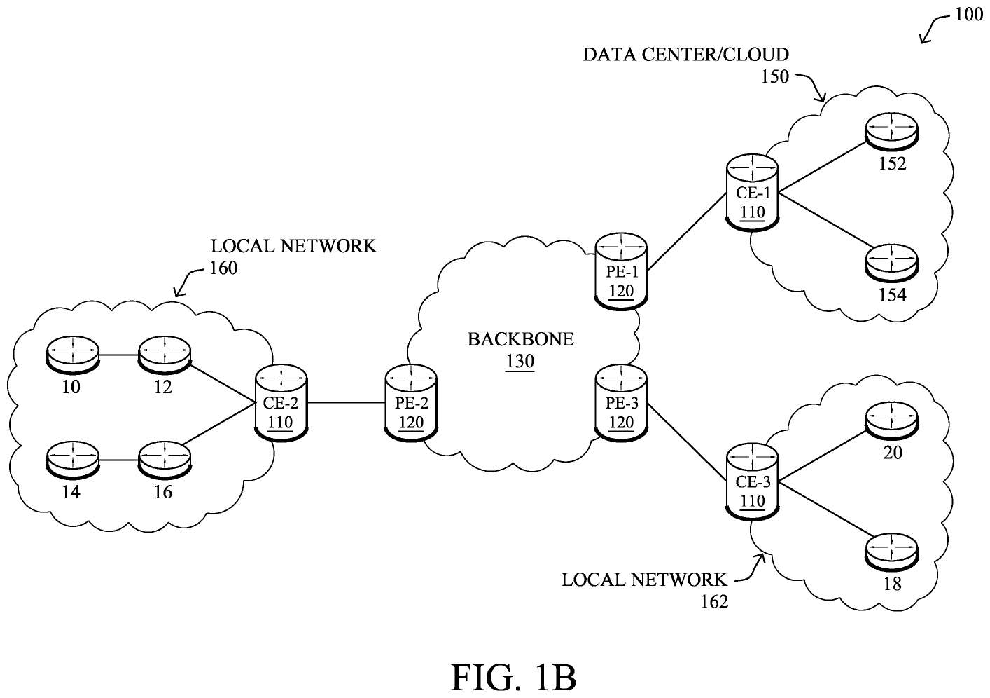

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection). Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

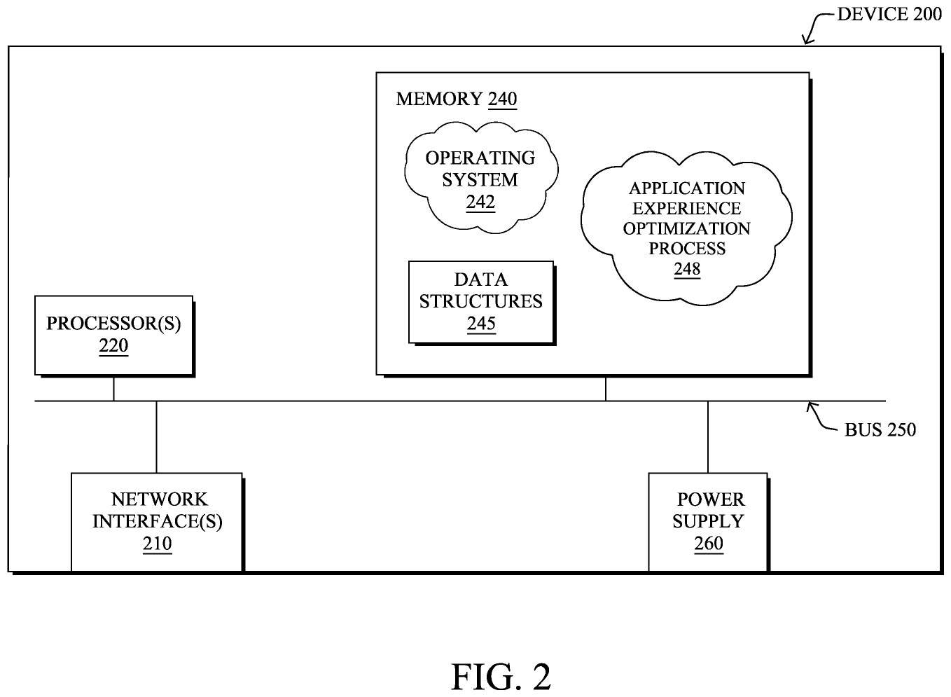

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise an application experience optimization process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, application experience optimization process 248 may include computer executable instructions executed by the processor 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, application experience optimization process 248 may consist solely of providing mechanisms necessary for source routing techniques. That is, for source routing, other devices in the network can tell the less capable devices exactly where to send the packets, and the less capable devices simply forward the packets as directed.

In various embodiments, as detailed further below, application experience optimization process 248 may include computer executable instructions that, when executed by processor(s) 220, cause device 200 to perform the techniques described herein. To do so, in some embodiments, application experience optimization process 248 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, application experience optimization process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that application experience optimization process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software-as-a-service (SaaS) is having a dramatic impact of the overall Internet due to the extreme virtualization of services and shift of traffic load in many large enterprises. Consequently, a branch office or a campus can trigger massive loads on the network.

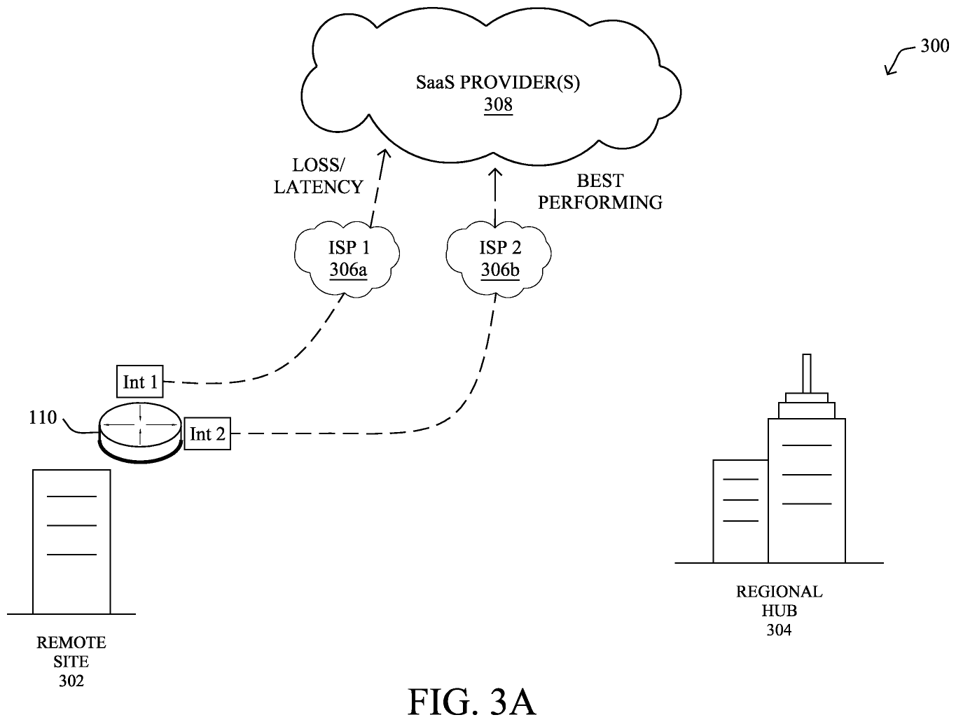

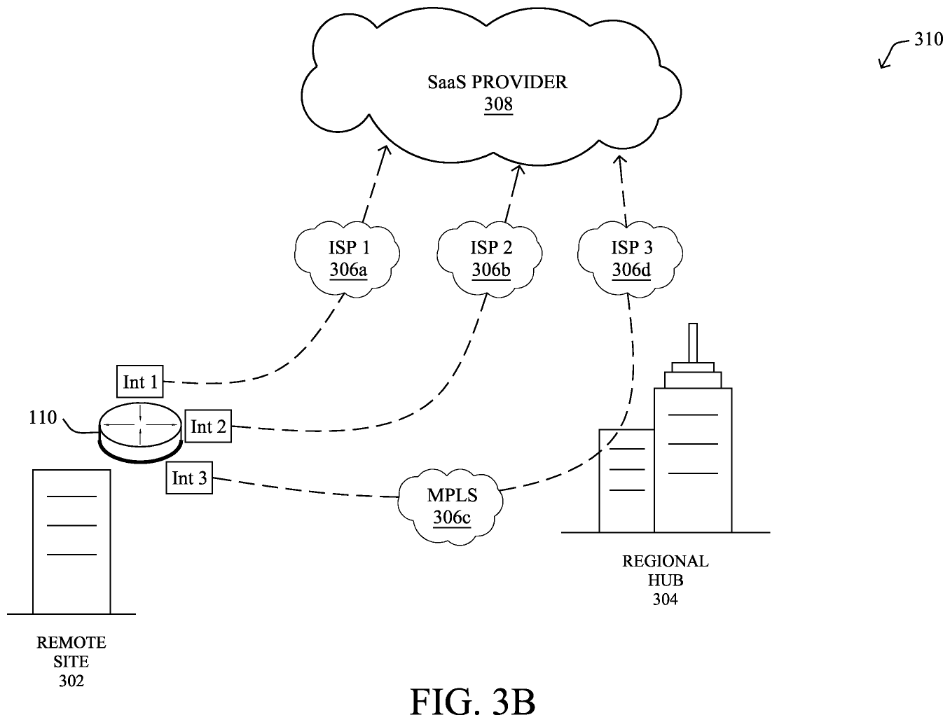

FIGS. 3A-3B illustrate example network deployments 300, 310, respectively. As shown, a router 110 located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., OFFICE 365™, Dropbox™, etc.) served by SaaS provider(s) 308.

As would be appreciated, SD-WANs allow for the use of a variety of different pathways between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

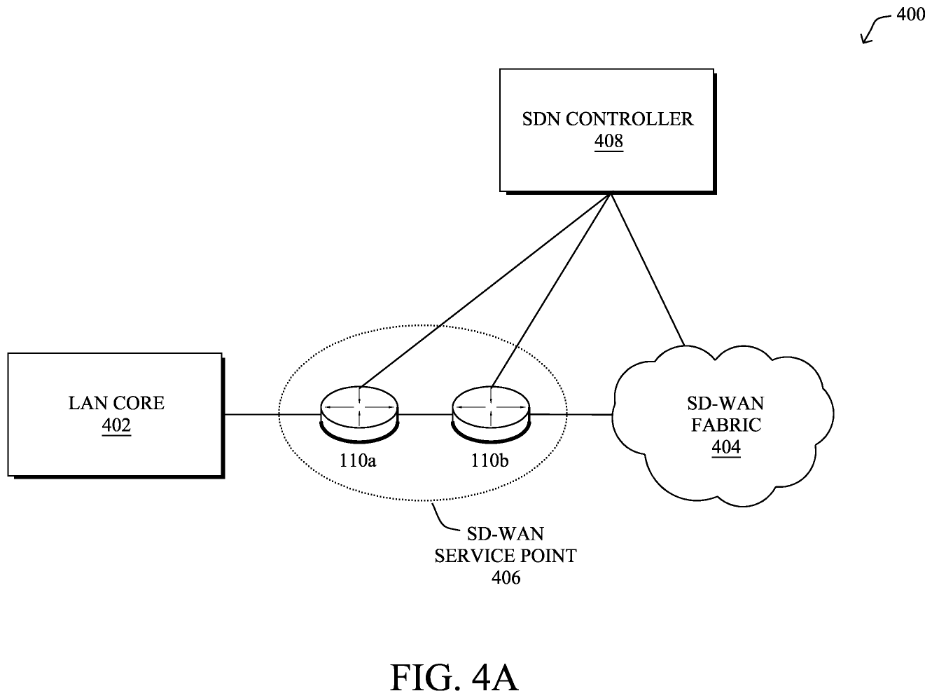

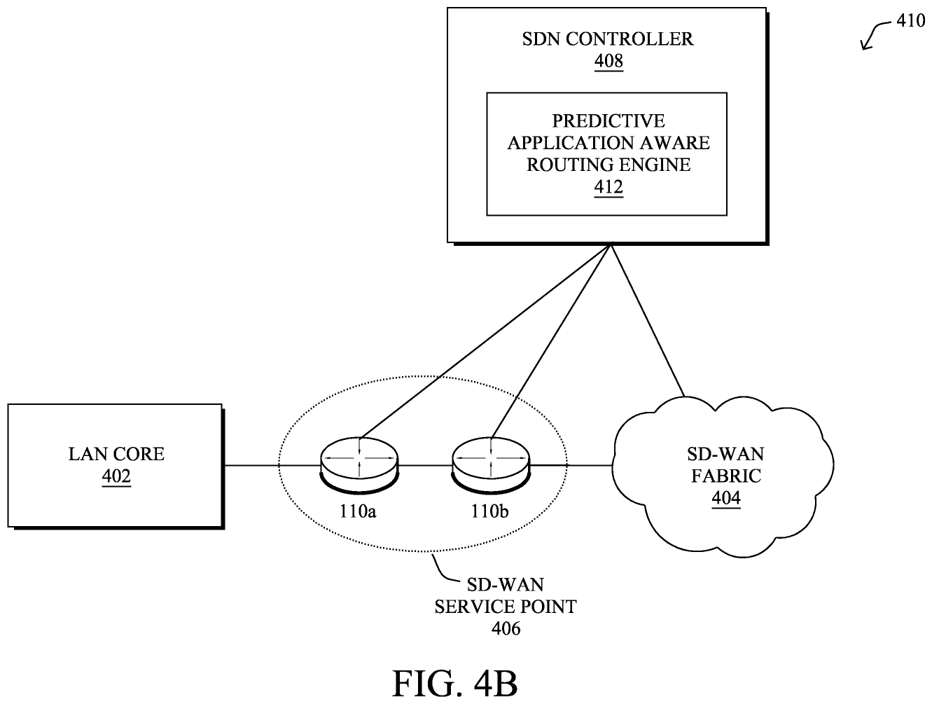

FIG. 4A illustrates an example SDN implementation 400, according to various embodiments. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance. SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., a device 200) configured to provide a supervisory service, typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging an SaaS model. Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side. SD-WAN provides a high degree of flexibility allowing for efficient configuration management using SDN controllers with the ability to benefit from a plethora of transport access (e.g., MPLS, Internet with supporting multiple CoS. LTE, satellite links, etc.), multiple classes of service and policies to reach private and public networks via multi-cloud SaaS.

Furthermore, the level of dynamicity observed in today's network has never been so high. Millions of paths across thousands of Service Provides (SPs) and a number of SaaS applications have shown that the overall QoS(s) of the network in terms of delay, packet loss, jitter, etc. drastically vary with the region, SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions;
SaaS applications themselves being highly dynamic: it is common to see new servers deployed in the network. DNS resolution allows the network for being informed of a new server deployed in the network leading to a new destination and a potentially shift of traffic towards a new destination without being even noticed.

According to various embodiments, application aware routing usually refers to the ability to rout traffic so as to satisfy the requirements of the application, as opposed to exclusively relying on the (constrained) shortest path to reach a destination IP address. Various attempts have been made to extend the notion of routing, CSPF, link state routing protocols (ISIS, OSPF, etc.) using various metrics (e.g., Multi-topology Routing) where each metric would reflect a different path attribute (e.g., delay, loss, latency, etc.), but each time with a static metric. At best, current approaches rely on SLA templates specifying the application requirements so as for a given path (e.g., a tunnel) to be “eligible” to carry traffic for the application. In turn, application SLAs are checked using regular probing. Other solutions compute a metric reflecting a particular network characteristic (e.g., delay, throughput, etc.) and then selecting the supposed ‘best path,’ according to the metric.

The term ‘SLA failure’ refers to a situation in which the SLA for a given application, often expressed as a function of delay, loss, or jitter, is not satisfied by the current network path for the traffic of a given application. This leads to poor QoE from the standpoint of the users of the application. Modern SaaS solutions like Viptela, CloudonRamp SaaS, and the like, allow for the computation of per application QoE by sending HyperText Transfer Protocol (HTTP) probes along various paths from a branch office and then route the application's traffic along a path having the best QoE for the application. At a first sight, such an approach may solve many problems. Unfortunately, though, there are several shortcomings to this approach:
The SLA for the application is ‘guessed,’ using static thresholds.
Routing is still entirely reactive: decisions are made using probes that reflect the status of a path at a given time, in contrast with the notion of an informed decision.
SLA failures are very common in the Internet and a good proportion of them could be avoided (e.g., using an alternate path), if predicted in advance.

In various embodiments, the techniques herein allow for a predictive application aware routing engine to be deployed, such as in the cloud, to control routing decisions in a network. For instance, the predictive application aware routing engine may be implemented as part of an SDN controller (e.g., SDN controller 408) or other supervisory service, or may operate in conjunction therewith. For instance, FIG. 4B illustrates an example 410 in which SDN controller 408 includes a predictive application aware routing engine 412 (e.g., through execution of application experience optimization process 248). Further embodiments provide for predictive application aware routing engine 412 to be hosted on a router 110 or at any other location in the network.

During execution, predictive application aware routing engine 412 makes use of a high volume of network and application telemetry (e.g., from routers 110a-110b, SD-WAN fabric 404, etc.) so as to compute statistical and/or machine learning models to control the network with the objective of optimizing the application experience and reducing potential down times. To that end, predictive application aware routing engine 412 may compute a variety of models to understand application requirements, and predictably route traffic over private networks and/or the Internet, thus optimizing the application experience while drastically reducing SLA failures and downtimes.

In other words, predictive application aware routing engine 412 may first predict SLA violations in the network that could affect the QoE of an application (e.g., due to spikes of packet loss or delay, sudden decreases in bandwidth, etc.). In other words, predictive application aware routing engine 412 may use SLA violations as a proxy for actual QoE information (e.g., ratings by users of an online application regarding their perception of the application), unless such QoE information is available from the provider of the online application. In turn, predictive application aware routing engine 412 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one embodiment. In general, routing configuration changes are also referred to herein as routing “patches.” which are typically temporary in nature (e.g., active for a specified period of time) and may also be application-specific (e.g., for traffic of one or more specified applications).

As noted above, enterprise networks have undergone a fundamental transformation whereby users and applications have become increasingly distributed whereby technologies such as SD-WAN, Hybrid Work, and Zero Trust Network Access (ZTNA) have enabled unprecedented flexibility in terms of network architecture and underlay connectivity options. At the same time, collaboration applications, which are often critical for day-to-day business operations, have moved from on-premises deployment to a SaaS cloud delivery model that allows application vendors to rapidly deploy and take advantage of the latest and greatest codecs that can be used to increase robustness of media content.

In this highly dynamic environment, the ability of network administrators to understand the impact of network performance (or lack of) on the QoE of online applications, as well as ensuring that the proper SLAs are satisfied, is becoming increasingly challenging. Indeed, in years past, network metrics were used as a proxy for the true application QoE, with SLAs being set, accordingly. For instance, in the case of a voice application, the usual SLA boundaries are 150 ms for delay, 50 ms for jitter, and maximum of 3% packet loss. Today, such values are not as clear-cut. For example, two real-time voice calls may have different loss thresholds based on the audio codec being used whereby a voice application that uses a lossy codec such as Opus may be resistant until a packet loss of up to 30%, whereas other audio codecs, such as advanced audio coding (AAC), are usually not resilient to such high loss thresholds.

Another factor that demonstrates the shortfalls of relying on SLA thresholds as a proxy for the true application QoE is that SLAs are set without any consideration to the granularity of their underlying measurements. For instance, a path experiencing a constant delay of 120 ms for voice over a period of 10 minutes provides a very different user experience than a path with the same average delay that keeps varying between 20 and 450 ms, despite averaging out to the same over the time period. The dynamics of such metrics is even more critical for packet loss and jitter in the case of voice and video traffic (e.g. ten seconds of 80% packet loss would severely impact the user experience although averaged out over ten minutes would give a low value totally acceptable according to the threshold). Without a doubt, the user experience requires a more subtle and accurate approach in order to determine the networking requirements a path should meet in order to maximize the user satisfaction, capturing local phenomenon (e.g. effects on delay, jitter and loss at higher frequencies) but also telemetry from upper layers (applications).

Traditionally, a core principle of the Internet has been layer isolation. Such an approach allowed layer dependency (e.g. often referred to as layer violation) to be avoided, at a time where a number of protocols and technologies were developed at each layer. More specifically, the Open Systems Interconnection (OSI) model divides networks into seven networking layers:
1. The Physical (PHY) Layer—the layer representing the physical connections between devices
2. The Data Link Layer—e.g., the layer at which MAC addressing is used
3. The Network Layer—e.g., the layer at which the IP protocol is used
4. The Transport Layer—e.g., the layer at which TCP or UDP
5. The Session Layer—e.g., the layer at which a given session between endpoints is managed
6. The Presentation Layer—e.g., the layer that translates requests from the application layer to the session layer and vice-versa

7. The Application Layer—e.g., the highest layer at which the application itself operates

This allowed for the design and deployment of new layers (e.g. PHY, MAC, etc.) independent of each other, and allowing the Internet to scale. Still, with modern applications requiring tight SLAs, a cross-layer approach would be highly beneficial to optimizing the QoE of any given online application.

Further, even with a mechanism that is able to accurately estimate the application experience from the perspective of a user, another challenge still exists with respect to selecting the appropriate network action to improve the experience. Indeed, although the effect of specific actions at a given layer of the networking stack on user experience can be qualitatively evaluated, being able to precisely quantify it is often unknown. For instance, determining that voice quality is low along a highly congested path may be relatively easy. However, determining the correct amount of bandwidth to allocate to the path or the appropriate queue weight for the traffic of the application still remains quite challenging.

According to various embodiments, application experience optimization process 248 may leverage the concept of cognitive networking. Instead of taking a siloed approach where networking systems poorly understand user satisfaction, cognitive networks are fully driven by understanding user experience (cognition) using cross-layer telemetry and ground truth user feedback, in order to determine which networking actions can optimize the user experience. To that end, a rich set of telemetry sources are gathered along with labeled user feedback in order to train a machine learning model to predict/forecast the user experience (i.e., the QoE of an online application). Such a holistic approach that is end-to-end across the different network layers is a paradigm shift to how networks have been designed and operated since the early days of the Internet.

As noted above, user feedback regarding the QoE of an application represents excellent ground truth on which a QoE prediction model can be trained. In turn, such a model can then be used to help optimize the QoE of the application through control of the network using predictive routing or cognitive networking approaches. To garner such feedback, the system may query users of the application for their subjective ratings regarding their experiences, either within the application itself or using external mechanisms, such as a chatbot agent installed on their endpoint devices, via text messaging, via email, or in any other way. Of course, collecting meaningful feedback datasets for training QoE prediction models require many users to participate in the data collection process, which requires investing time and energy. In addition, such a feedback mechanism can quickly become annoying to the users, leading them to start ignoring the feedback requests entirely or affecting their satisfaction ratings.

When bootstrapping a QoE prediction model and collecting feedback and other training data for a new application, the initial estimates of the QoE may be poor until sufficient data is available. One approach to this might entail collecting such data based on the initial estimates to start with, as randomly sampling without any guiding model can lead to datasets that are not informative enough for QoE modeling. As the system starts to collect user feedback, it can train slightly better models which, in turn, can help better focus on interesting situations and collect more informative user feedback.

In that context, it makes sense to progressively onboard users of a large company or other enterprise based on how useful querying information from them might be. For example, a group of users in a location known to be difficult for the target application can be onboarded first, as it might provide the most informative early feedback. Alternatively, some users may be using rather rare and specific features (e.g., codec settings, advanced features of the application), and targeting them for data collection may be important to produce a QoE model that is general enough. Conversely, continuing to collect feedback from users for whom the model has already enough information (good coverage of the input space) is not useful and would drain time and user energy, unnecessarily.

In addition, when a user has started participating in a feedback collection program, the choice of the right moment to request feedback is capital. For instance, when is the best time to get some feedback from a user that spends six hours a day in video calls every day, given a budget of one query per day? In some instances, the system could use simple heuristics, such as instantaneous application scores, to control when users are queried for feedback. However, doing so may not provide the most useful information for at least the following reasons:
It might lead to the system issuing a feedback request too early during the day, while a more interesting situation may present itself later when the query budget has been consumed, already.
It might lead to the system issuing a feedback request during a situation where the QoE is poor, but that situation has already been well captured by the QoE model, thereby providing little additional information. For example, a situation where packet loss is 100% is likely easy for the model to model, and it may not be useful to collect more information for such situations. Instead, it might be more fruitful to collect information from the user in much fewer clear-cut cases where the model may be uncertain as to the QoE.

### —User Feedback Collection for Application QoE Prediction—

The techniques herein allow for the collection of user labels/QoE feedback in a for collecting user labels in a sample-efficient manner, by leveraging two levels of active learning: 1.) by automatically onboarding new users to the data collection program based on how interesting their data may be and/or 2.) by selecting when to query onboarded users for QoE feedback using feature vectors (or sequences thereof, to capture time-based patterns), and the current model uncertainty (to focus queries on the more informative cases to decrease the overall uncertainty of the model in hard-to-predict situations). In some aspects, this active learning strategy allows the system to quickly (re) train QoE prediction models that are able to accurately predict the QoE across a large range of situations, including more fringe ones, with only a limited budget of user feedback queries.

Illustratively, the techniques described herein may be performed by hardware, software, and/or firmware, such as in accordance with application experience optimization process 248, which may include computer executable instructions executed by the processor 220 (or independent processor of interfaces 210) to perform functions relating to the techniques described herein.

Specifically, according to various embodiments, a device makes, using a prediction model, a prediction regarding a quality of experience metric for an online application, based on telemetry from a network used to access the network. The device determines a degree of uncertainty associated with the prediction. The device selects one or more users of the online application from which user feedback should be requested, based on the degree of uncertainty. The device requests that the one or more users provide user feedback regarding their satisfaction with the online application.

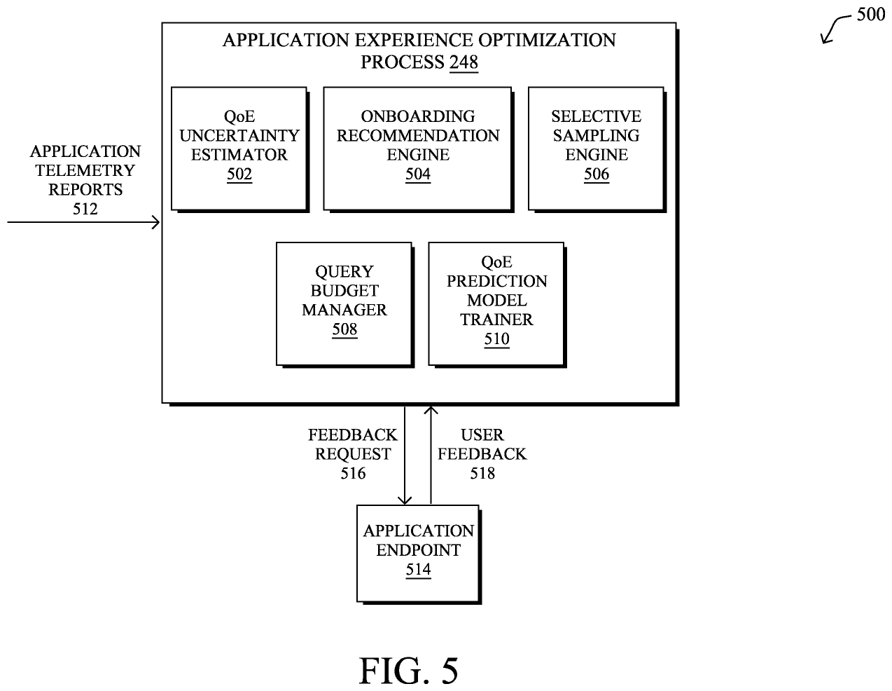

Operationally, FIG. 5 illustrates an example architecture 500 for application selection based on network characteristics, according to various embodiments. At the core of architecture 500 is application experience optimization process 248, which may be executed by a controller for a network or another device in communication therewith. For instance, application experience optimization process 248 may be executed by a controller for a network (e.g., SDN controller 408 in FIGS. 4A-4B), a particular networking device in the network (e.g., a router, a firewall, etc.), a server, another device or service in communication therewith, or the like.

As shown, application experience optimization process 248 may include any or all of the following components: QoE uncertainty estimator 502, onboarding recommendation engine 504, selective sampling engine 506, query budget manager 508, and/or QoE prediction model trainer 510. As would be appreciated, the functionalities of these components may be combined or omitted, as desired. In addition, these components may be implemented on a singular device or in a distributed manner, in which case the combination of executing devices can be viewed as their own singular device for purposes of executing application experience optimization process 248.

According to various embodiments, application experience optimization process 248 may obtain application telemetry reports 512. In general, application telemetry reports 512 may include telemetry collected from the network, from the application itself, and/or from the client endpoints operated by the users of the application. For example, application telemetry reports 512 may indicate performance metrics for the network such as, but not limited to, loss, latency, jitter, bandwidth, resource usage, or the like. In addition, application telemetry reports 512 may be generated directly by the online application under scrutiny that may also indicate impairment scenarios, such as, but not limited to, the bitrate, framerate, concealment time, bandwidth, video HBH Loss, video E2E, etc.

Further information that application telemetry reports 512 may include may be user feedback provided by users of the application indicative of their satisfaction with their application experience (e.g., QoE metrics based on real user feedback). For instance, application experience optimization process 248 may send a feedback request 516 to application endpoint 514 operated by a user of a given application, asking them to rate their experience with the application. In various embodiments, feedback request 516 may be presented to that user via a chatbot, endpoint agent, within the application itself, as a pop-up message, or the like. In turn, the user of application endpoint 514 may provide user feedback 518 indicative of their satisfaction with their application experience.

In some embodiments, application experience optimization process 248 may first ‘onboard’ users its feedback collection functions, prior to asking them to rate their application experiences. For example, the chatbot or other query mechanism may first ask the user whether they are willing to participate, users may be required to undergo training first, etc. Once a user is considered onboarded, they may then be eligible for application experience optimization process 248 to query them regarding their experiences in one or more applications. Thus, the set of USERS may comprise the full set of users of the application for a given enterprise (e.g., business, school, etc.), whereas the set of ONBOARDED_USERS may be the set of those users that have actually been onboarded. Typically, the set of onboarded users will take the form of a subset of the full set of users.

By way of example of application telemetry reports 512, consider the case of a video conferencing application. In such a case, application telemetry reports 512 may take the form of periodic reports summarizing 60 s of a given call for a given user, with data such as bitrates, framerates, codec information, network metrics, etc. These reports may also be encoded as feature vectors following usual machine learning practices. For the sake of illustration, such reports may be collected via a backend system for the videoconferencing application (e.g., Webex, etc.) that provides dozens of telemetry datapoints per minute of active calls for all of the potential users.

According to various embodiments, QoE uncertainty estimator 502 may leverage a QoE prediction model trained by QoE prediction model trainer 510 and implement a model training mechanism to train and set hyperparameters for the model. For instance, the trained QoE prediction model may predict the QoE for a given user (e.g., as a binary “Acceptable’ or “Unacceptable” label, as a rating on a scale of 1-5 or other scale, etc.). In one embodiment, the model may also generate an uncertainty score associated with any of its predictions. In effect, a high degree of uncertainty means that the model was not exposed to enough samples for the input conditions to confidently predict on the input feature vector. In one embodiment, this template model could be instantiated directly.

In another embodiment, the template QoE prediction model may not output an uncertainty score but only a prediction. In this case, QoE uncertainty estimator 502 could instead leverage a query-by-committee or similar setup, such as query-by-bagging, query-by-boosting, or other variants. These methods generate multiple model instantiations from the template model by feeding them different datasets, random seeds, or parameters, to obtain an ensemble of models. QoE uncertainty estimator 502 could then evaluate these models on an input feature vector, producing a set of output predictions and use the distributions of these predictions to compute an uncertainty score. Here, if the predictions are all very close, this could be viewed as indicative of certainty. Conversely, if there are large variations in the predictions, this could mean a high degree of uncertainty.

In all cases, QoE uncertainty estimator 502 may take as input the feature vectors for the QoE prediction model(s) and outputs predictions as well as uncertainty scores. As an example, QoE uncertainty estimator 502 could use an ensemble of gradient-boosted trees or of deep neural networks (e.g., taking sequences of feature vectors as input with an attention mechanism.

In some embodiments, QoE uncertainty estimator 502 may need to initiate retraining of the model(s) via QoE prediction model trainer 510, to consider the effect of recently collected labels/feedback on the overall uncertainty of predictions. For instance, QoE uncertainty estimator 502 may initiate periodic model retraining on a daily or other periodic basis, on demand, or in response to a trigger condition being met.

Here, it is important to select the most appropriate architecture for QoE uncertainty estimator 502, to collect the most informative user feedback. To do so, application experience optimization process 248 could leverage A/B testing with two different approaches for QoE uncertainty estimator 502 and a given QoE prediction model, to decide between the two approaches. In such a case, each instance of QoE uncertainty estimator 502 may train its own QoE prediction model via QoE prediction model trainer 510 and the performance of these two models compared using a separate testing dataset. For instance, application experience optimization process 248 may compute the log loss, area under curve (AUC), or other such metrics. The instance which produced the dataset that yielded the highest QoE model performance is the most suitable, as it produced the most informative dataset.

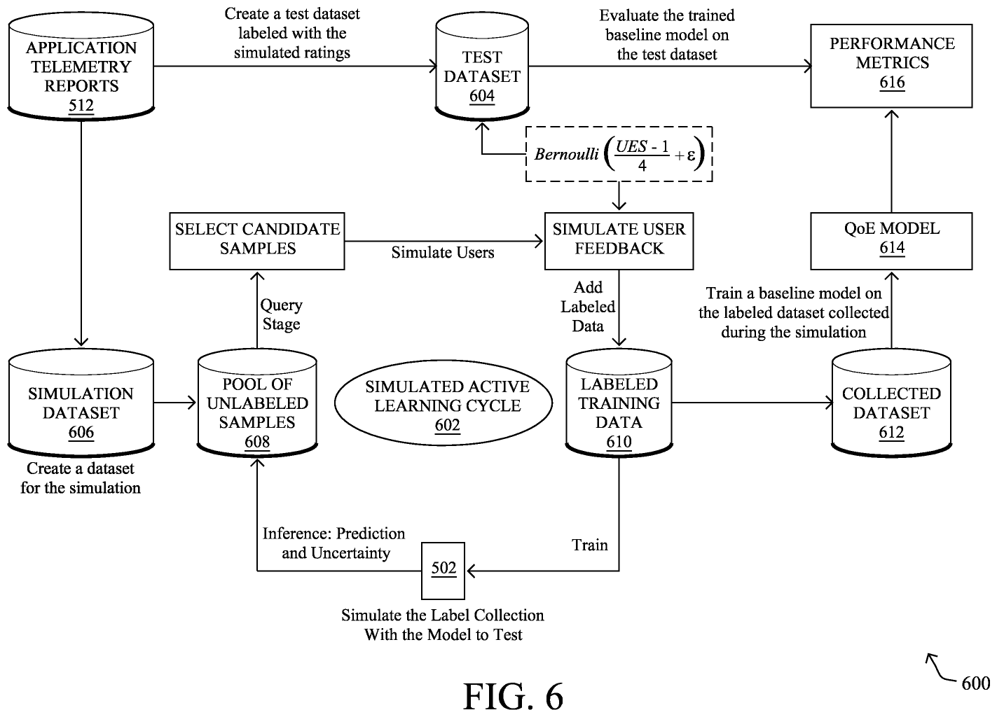

An alternative approach based on active learning simulations is also possible, in further embodiments. This approach is very similar to the above A/B testing methodology, except that it is conducted in an offline fashion using simulated user feedback. This approach is less costly than A/B testing campaigns, but it requires a meaningful user feedback simulator to generalize the results to real user feedbacks. By way of example, FIG. 6 illustrates an example 600 of such an approach to implement QoE uncertainty estimator 502.

As shown in FIG. 6, assume that there is history of application telemetry reports 512. In such a case, application experience optimization process 248 may use this data to form a simulation dataset 606 from which there is a pool 608 of unlabeled samples (i.e., telemetry data lacking corresponding user QoE feedback). In turn, application experience optimization process 248 may implement a simulated active learning cycle 602 whereby application experience optimization process 248 selects candidate samples from pool 608, simulates users and their feedback, to form labeled training data 610. In turn, application experience optimization process 248 may use this labeled training data 610 to then train QoE uncertainty estimator 502. This results in a collected dataset 612 and corresponding QoE model 614.

By way of example, to simulate the user feedback, application experience optimization process 248 may evaluate a Bernoulli distribution with a parameter based on the application User Experience Score (UES) which is a deterministic quality score. For example, such a score may be between the range of 1-5 and computed from network and/or application performance metrics. This simulation allows application experience optimization process 248 to compare multiple instances of QoE uncertainty estimator 502 by monitoring the performance of the QoE model (e.g., a LightGBM model) trained on the samples collected by the different instances.

Once QoE model 614 has been trained, application experience optimization process 248 may also form a test dataset 604 from application telemetry reports 512 and evaluate the performance of QoE model 614 on it, to generate performance metrics 616.

Referring again to FIG. 5, onboarding recommendation engine 504 may monitor the stream of predictions and uncertainties from QoE uncertainty estimator 502 and compute statistics for those users not currently onboarded to the feedback mechanism. At a regular interval, onboarding recommendation engine 504 may select the top n-number of users to onboard based on those statistics. For instance, onboarding recommendation engine 504 may compute the daily maximum uncertainty per user (or a percentile of that distribution for more robustness) and output the ten users with the highest value. In some embodiments, onboarding recommendation engine 504 may also be configured to select users for onboarding in accordance with a budget of users that can be onboarded by time interval, so as not to be too intrusive to the overall population of users.

In one embodiment, onboarding recommendation engine 504 may be refined to use weightings of users reflecting the odds that they might accept to participate in the feedback mechanism. For instance, application experience optimization process 248 may allow users to decline participating when asked. Alternatively, the user may accept to participate but not provide any label when queried. This can lead to the budget of onboarding recommendation engine 504 being wasted. Instead, onboarding recommendation engine 504 may:
Keep track of users that have been selected, and whether they have started providing labels/feedback, actively.
Train a machine learning model mapping from user characteristics (e.g., location and other directory information), as well as past user feature vectors, to a binary label indicating whether the user has accepted to participate and has actually started providing labels. For example, a simple model can simply track the fraction of successful onboardings per country or region, and output probabilities between 0 and 1.
When producing a recommendation of users to onboard, weight each user by the probability estimated by such model. A user for which the model is certain of onboarding will count towards 1 unit of the budget. A user for which the model probability is 0.5 will count towards 0.5 units of the budget only, so that onboarding recommendation engine 504 can output more user recommendations if they are not so likely to accept.

Onboarding recommendation engine 504 may then keep some state about users who already received an onboarding request, so as not to produce the same set of recommendations multiple times.

In various embodiments, selective sampling engine 506 may be configured to evaluate the scores computed by QoE uncertainty estimator 502 and send feedback requests, such as feedback request 516, based on the uncertainty scores. In other words, the goal of selective sampling engine 506 is to selectively ask users for feedback, focusing in on situations in which the QoE prediction has high uncertainty. Obtaining such feedback allows application experience optimization process 248 to update the training dataset for the prediction model.

In some instances, selective sampling engine 506 can use a function that maps each feature vector to a sampling probability based on its associated uncertainty. This function can be a parameterizable function (e.g., an increasing piecewise linear function of the uncertainty) calibrated on a back test over historical data to minimize the overall sample uncertainty under constraints of budget and volume of collected feedback.

When the model uses sequences of feature vectors, selective sampling engine 506 could use specific modelling to take the time component into account. In one embodiment, selective sampling engine 506 could also identify failure patterns, as well. In such a setting, application failure patterns are identified offline using clustering techniques, leading to a set of patterns on how application failures can arise and sustain themselves. Selective sampling engine 506 can then derive failure patterns by inspecting weights for attention mechanisms in deep neural networks, or by using other techniques such as Shapely values. Two examples of patterns are: (i.) an impact slowly increasing over time, or (ii.) a short impact increasing and decreasing very quickly, although other application-specific patterns are possible. When considering a feature vector for a feedback query, the current sequence of feature vectors can be transformed into the pattern space and classified into one of these failure patterns by computing a distance or correlation metric in that space (e.g., using a translation-invariant distance which can account for the fact that the sequence may consist in only the beginning of a pattern). The function mapping inputs and their uncertainty to sampling probability can then be tuned by selective sampling engine 506 specifically for each pattern (e.g., for a pattern with a slowly increasing impact, the function can be tuned to delay sampling until larger values of uncertainty arise).

In various embodiments, query budget manager 508 may be configured to dynamically adapt the query budget for each user according to the value of their feedback for the model, or to the willingness of the user to provide more or less feedback. For example, one such budget may limit application experience optimization process 248 from asking for feedback more than one per day, per user. In some embodiments, query budget manager 508 may evaluate the level of uncertainty and dynamically ask a user whether they would agree to provide more feedback. Such an explicit “opt-in” could also be validated on a regular basis in order to check that the user is not “tired” of such requests, which would lead to declining label quality over time.

In greater details, query budget manager 508 could proactively monitor the behavior of such users after they accepted to provide more feedback and, should it notice a decrease in the number or the latency of the replies, ask them whether they still agree to participate in the feedback mechanism. In case the user rejects the proposal, the system falls back to the original static budget (at most N requests per day). This dynamic budget allocation can be driven explicitly by the dynamically computed uncertainty by QoE uncertainty estimator 502, in some embodiments.

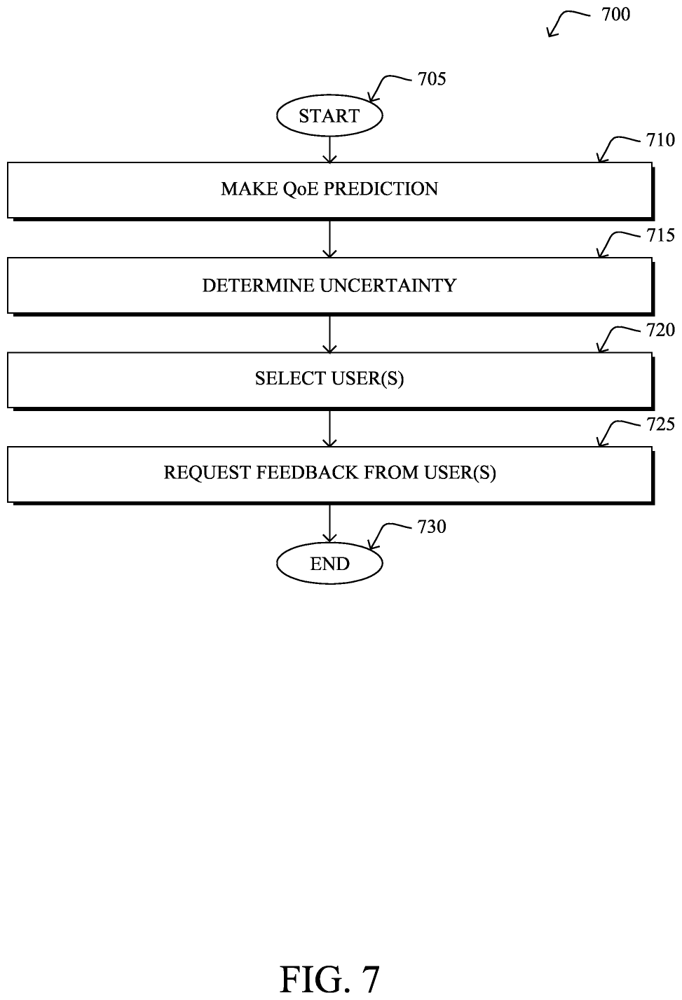

FIG. 7 illustrates an example simplified procedure 700 (e.g., a method) procedure for user feedback collection for application QoE prediction, in accordance with one or more embodiments described herein. For example, a non-generic, specifically configured device (e.g., device 200), such as a router, firewall, controller for a network (e.g., an SDN controller or other device in communication therewith), server, or the like, may perform procedure 700 by executing stored instructions (e.g., application experience optimization process 248). The procedure 700 may start at step 705, and continues to step 710, where, as described in greater detail above, the device may make, using a prediction model, a prediction regarding a quality of experience metric for an online application, based on telemetry from a network used to access the network. In one embodiment, the prediction model is used to make a configuration change in the network, based on its predictions. In one embodiment, the device may do so based further in part on telemetry data from the online application.

At step 715, as detailed above, the device may determine a degree of uncertainty associated with the prediction. In some embodiments, the device may do so in part by simulating user feedback.

At step 720, the device may select one or more users of the online application from which user feedback should be requested, based on the degree of uncertainty, as described in greater detail above. In various embodiments, the device may select the one or more users from among a pool of users onboarded to provide feedback regarding the online application. In one embodiment, the device may onboard a particular user to provide the feedback in part by requesting that the particular user opt in to providing the feedback. In further embodiments, the device may select the one or more users based in part on a query budget that limits how many requests for user feedback can be sent within a given time period. In another embodiment, the device may select the one or more users based in part on their location.

At step 725, as detailed above, the device may request that the one or more users provide user feedback regarding their satisfaction with the online application. In various embodiments, the device may also update the prediction model using the user feedback from the one or more users. In one embodiment, the device may request the user feedback via a chatbot.

Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for user feedback collection for application QoE prediction, it is to be understood that various other adaptations and modifications may be made within the spirit and scope of the embodiments herein. For example, while certain embodiments are described herein with respect to using certain models for purposes of predicting application experience metrics, SLA violations, or other disruptions in a network, the models are not limited as such and may be used for other types of predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
making, by a device and using a prediction model, a prediction regarding a quality of experience metric for an online application, based on telemetry from a network used to access the network;
determining, by the device, a degree of uncertainty associated with the prediction;
selecting, by the device, one or more users of the online application from which user feedback should be requested, based on the degree of uncertainty and a query budget that limits how many requests for user feedback can be sent within a given time period; and
requesting, by the device, that the one or more users provide user feedback regarding their satisfaction with the online application.

2. The method as in claim 1, further comprising:
updating the prediction model using the user feedback from the one or more users.

3. The method as in claim 1, wherein the device selects the one or more users from among a pool of users onboarded to provide feedback regarding the online application.

4. The method as in claim 3, further comprising:
onboarding a particular user to provide the feedback in part by requesting that the particular user opt in to providing the feedback.

5. (canceled)

6. The method as in claim 1, wherein the prediction model is used to make a configuration change in the network, based on its predictions.

7. The method as in claim 1, wherein the device selects the one or more users based in part on their location.

8. The method as in claim 1, wherein the device determines the degree of uncertainty based in part by simulating user feedback.

9. The method as in claim 1, wherein the device predicts the quality of experience metric based further in part on telemetry data from the online application.

10. The method as in claim 1, wherein the device request the user feedback via a chatbot.

11. An apparatus, comprising:
one or more network interfaces;
a processor coupled to the one or more network interfaces and configured to execute one or more processes; and
a memory configured to store a process that is executable by the processor, the process when executed configured to:
make, using a prediction model, a prediction regarding a quality of experience metric for an online application, based on telemetry from a network used to access the network;
determine a degree of uncertainty associated with the prediction;
select one or more users of the online application from which user feedback should be requested, based on the degree of uncertainty and a query budget that limits how many requests for user feedback can be sent within a given time period; and
request that the one or more users provide user feedback regarding their satisfaction with the online application.

12. The apparatus as in claim 11, wherein the process when executed is further configured to:
update the prediction model using the user feedback from the one or more users.

13. The apparatus as in claim 11, wherein the apparatus selects the one or more users from among a pool of users onboarded to provide feedback regarding the online application.

14. The apparatus as in claim 13, wherein the process when executed is further configured to:
onboarding a particular user to provide the feedback in part by requesting that the particular user opt in to providing the feedback.

15. (canceled)

16. The apparatus as in claim 11, wherein the prediction model is used to make a configuration change in the network, based on its predictions.

17. The apparatus as in claim 11, wherein the apparatus selects the one or more users based in part on their location.

18. The apparatus as in claim 11, wherein the apparatus determines the degree of uncertainty based in part by simulating user feedback.

19. The apparatus as in claim 11, wherein the apparatus predicts the quality of experience metric based further in part on telemetry data from the online application.

20. A tangible, non-transitory, computer-readable medium storing program instructions that cause a device to execute a process comprising:
making, by the device and using a prediction model, a prediction regarding a quality of experience metric for an online application, based on telemetry from a network used to access the network;
determining, by the device, a degree of uncertainty associated with the prediction;
selecting, by the device, one or more users of the online application from which user feedback should be requested, based on the degree of uncertainty and a query budget that limits how many requests for user feedback can be sent within a given time period; and
requesting, by the device, that the one or more users provide user feedback regarding their satisfaction with the online application.
